(19) United States
(12) Patent Application Publication
(10) Pub. No.: US 2004/0002315 A1
(43) Pub. Date: Jan. 1, 2004

(54) Harmonic boost signals in up/down direct/super heterodyne conversions for advanced receiver/transmitter architecture

(76) Inventor: Ching-Lang Lin, Plano, TX (US)

Correspondence Address: HUGHES & LUCE LLP, 1717 MAIN STREET, SUITE 2800, DALLAS, TX, 75201, US

(21) Appl. No.: 10/353,749

(22) Filed: Jan. 29, 2003

Related U.S. Application Data
(60) Provisional application No. 60/392,077, filed on Jun. 28, 2002.
(60) Provisional application No. 60/392,104, filed on Jun. 28, 2002.
(60) Provisional application No. 60/392,723, filed on Jun. 28, 2002.

(51) Int. Cl. H04B 1/04; H01Q 11/12; H04B 1/00; H04B 1/06; H04B 7/00; H04B 1/26; H04B 15/00

(52) U.S. Cl. 455/255; 455/118; 455/131; 455/313; 455/323

(57) ABSTRACT

A harmonic boosting technique for achieving higher overall system performance is described here. The technique is applicable to devices such as converter, combiner, synthesizer, and voltage control oscillator. A converter has anti-parallel diode pair (hereafter called APDP) cell or a modified Gilbert cell circuit for mixing an input signal with local oscillator (hereinafter called LO). A combiner has a combining circuit to combine even harmonics from LO. A synthesizer has a digitally synthesized network or a multiplier circuit for producing the even harmonics. A voltage control oscillator (hereafter called VCO) has a voltage control circuit for generating very low base frequencies.

The principle object of this invention is to demonstrate that a harmonic boosting technique is capable of reducing LO power and frequency thus providing necessary solutions for achieving SOC chipset commercialization. In addition to the compact size, the SOC process using this technique will have lower cost, lower internal interference, lower power consumption and high lineraity.

### CROSS-REFERENCE TO RELATED APPLICATIONS

This application claims the benefit of and incorporates by reference U.S. Provisional Patent Application Serial No. 60/392,077 entitled “Harmonic Boost Signals In Up/Down Direct/Super Heterodyne Conversions For Advanced Receiver/ Transmitter Architecture,” filed on Jun. 28, 2002. Additionally, this patent application is related to and incorporates by reference U.S. Provisional Patent Application Serial No. 60/392,104, entitled “Square Wave Local Oscillator Technique for Direct Conversion Receiver”, filed on Jun. 28, 2002, for Ching-Lang Lin. Additionally, this application is related to and incorporates by reference U.S. Provisional Patent Application Serial No. 60/392,723, entitled “Improved Harmonic Boost Technique for Direct Conversion Receiver”, filed on Jun. 28, 2002, for Ching-Lang Lin.

### TECHNICAL FIELD OF THE INVENTION

The present invention relates to harmonic boosting techniques affecting the design and the performance of converters, combiners or adders, synthesizers or frequency multipliers, and voltage control oscillators. Such harmonic boosting techniques are useful in communications applications including wireless, satellite, radar, microwave, and radio systems. More specifically, the present invention relates to harmonic boosting techniques especially useful in reducing power consumption during boosting output signals while maintaining a high degree of linearity and low interior interference.

### BACKGROUND OF THE INVENTION

With the tremendous growth of wireless communication industry, and migration to higher frequency and bandwidth, the need for better high frequency mixing techniques continues to grow significantly. As a result, sub-harmonic mixing techniques, which historically have been used for millimeter-wave applications, are no longer strangers to mainstream wireless applications such as cell phone and wireless local area network (WLAN) systems. Sub-harmonic passive mixers that exhibit excellent linearity performance are becoming even more attractive for the next generation wireless hardware. However, the difficulty of integrating passive mixers on chip remains in the requirement of high LO (local oscillator) power, which leads to significant problems through radiation and substrate coupling and increases the power consumption of the LO buffers.

Currently, most communications and semiconductor companies have concentrated on the development of System On Chip (SOC) technology. However, SOC technology presents severe challenges in the area of heat dissipation and interior interference and manufacture process. Traditionally, up and down converters require the presence of a high frequency LO and synthesizer. Once a high frequency LO and synthesizer are introduced to the up and down converters, the associated parasitic capacitance and inductance causes increased power leakage which in turn leads to higher interior interference. Hence, the implementation of the SOC paradigm becomes more difficult.

In past years, harmonic implementations have focused on second sub-harmonic operations in the converters. However, there is a need for a harmonic boosting technique that uses multiple sub-harmonics with the inherent advantage of lower LO power and frequency. As a result, high frequency circuits causing coupling and matching issues are eliminated. In the meantime, the present invention allows interior interference to be reduced.

### SUMMARY OF THE INVENTION

The present invention demonstrates a harmonic boosting technique capable of reducing a LO power and frequency, thus providing one solution for achieving SOC chipset commercialization. SOC systems that use the harmonic boosting technique of the present invention have lower overall cost, internal interference, power consumption, while providing high linearity and compact benefits. Further, the present invention provides lower frequency operation devices including a converter, a combiner, a synthesizer and a VCO.

The present invention achieves this by providing circuits for different chipset applications with the harmonic boosting technique requirements described as follows.

This technique improves the implementation of SOC technology by providing a solution to current bottlenecks within the SOC process. Using the technique of the present invention, the RF subsystem will operate with a lower noise figure as well as lower overall power consumption. This is particularly useful in internet edge devices and wireless devices such as, but not limited to, current and future communications systems using GSM, GPRS, CDMA2000, WCDMA, DCS, and Blue Tooth, etc.

In one embodiment for a SOC chipset or a board-level application for transceivers, the harmonic boosting technique includes a voltage controlled oscillator (VCO). The VCO generates outputs:

LOₙᵣ=a receiving RF/2n; or

LOₙₜ=a transmitting RF/2n, where n=1, 2, 3, 4 . . .

A digital synthesizer or frequency multiplier device receives the output signal of the VCO and produces signals of two sets of output signals at n sub-output ports. These signals are LO₁ᵣ, LO₂ᵣ . . . LOₙᵣ at the first set of sub-output ports, and LO₁ₜ, LO₂ₜ . . . LOₙₜ; at the second;

LO₁ᵣ=a receiving RF/2;

LOₙᵣ=LO₁ᵣ/n;

LO₁ₜ=a transmitting RF/2; and

LOₙₜ=LO₁ₜ/n.

A combiner or adder that combines these output signals with inputs having frequencies LO₁ᵣ, LO₂ᵣ . . . LOₙᵣ and LO₁ₜ, LO₂ₜ . . . LOₙₜ, to generate the combiner's or adder's two outputs, LOᵣ for a down converter input and LOₜ for up converter input. An anti-parallel diode pair (APDP) circuit, a modified Gilbert circuit, or other like circuit as known to those skilled in the art may be used as the down converter. This APDP or modified Gilbert circuit, mixes an RF signal with the LOᵣ to produce a zero-IF or an IF signal. An APDP circuit, modified Gilbert cell, or other like circuit as known to those skilled in the art may also be used as the up converter to take a zero-IF signal or an IF signal with the LOₜ output to produce a transmitting RF output signal.

Additionally, other embodiments of the harmonic boosting technique may be constructed from a series of discrete devices in a transceiver for a board-level product or implementation. Here the functions are divided among a series of discrete devices, for example, the VCO circuit may be one discrete device that generates a frequency output. This frequency output which may include a received RF signal divided by 2n, LOₙᵣ or a transmitted RF signal divided by 2n, LOₙₜ or both LOₙᵣ and LOₙₜ. A discrete digital synthesizer or frequency multiplier device receives the VCO output and produces two sets of output signals that include n frequencies LO₁ᵣ, LO₂ᵣ LOₙᵣ in the first set, and LO₁ₜ, LO₂ₜ . . . LOₙₜ in the second set from an input comprising a frequency LOₙᵣ or LOₙₜ, where n=1, 2, 3, 4 . . . These two sets of signals are provided as the input to a discrete combiner or adder device. The combiner or adder, as stated previously, combines the two sets of outputs from the digital synthesizer or frequency multiplier device to create a LOᵣ output for a down converter LO frequency and an LOL output frequency for a up converter LO frequency.

An APDP cell, a modified Gilbert cell, or other like circuit as is known to those skilled in the art, forms part of the down converter device with a combiner or adder.

Similarly, the up converter circuit includes an APDP cell, modified Gilbert cell, or other like circuit as is known to those skilled in the art, and a combiner or adder.

Another embodiment for a digital synthesizer or frequency multiplier device, the digital synthesizer or frequency multiplier circuits include a digital synthesizer or frequency multiplier generating two sets of n outputs that include frequencies LO₁ᵣ, LO₂ᵣ . . . LOₙᵣ and frequencies LO₁ₜ, LO₂ₜ . . . LOₙₜ that are provided to an integrated combiner or adder as inputs. The combiner or adder portion of the discrete device combines the inputs having frequency which include LO₁ᵣ, LO₂ᵣ . . . LOₙᵣ and LO₁ₜ, LO₂ₜ . . . LOₙₜ frequencies, where n=1, 2, 3, 4 . . . , to generate an LOᵣ output for a down converter LO frequency and an LOₜ output frequency for a up converter LO frequency.

In another embodiment for a digital synthesizer or frequency multiplier device, the digital synthesizer or frequency multiplier circuits include a VCO circuit that generates an output that includes frequencies of a receiver RF divided by 2n, LOₙᵣ or a transmitting RF divided 2n, LOₙₜ or both LOₙᵣ and LOₙₜ, where n=1, 2, 3, 4 . . . This output is provided as the input to an integrated digital synthesizer or frequency multiplier. The digital synthesizer or frequency multiplier generating two sets of outputs that include n frequencies: LOᵣ, LO₂ᵣ . . . LOₙᵣ and LO₁ₜ, LO₂ₜ . . . LOₙₜ. These signals are provided to the integrated combiner or adder as inputs wherein the combiner or adder combines the n frequency inputs a LOᵣ output for a down converter LO frequency and an LOₜ output frequency for a up converter LO frequency.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 is a schematic diagram of preferred embodiment of the present invention configured as a harmonic boosting technique for a SOC chipset or a board-level application for transceiver;

FIG. 2 depicts a schematic diagram of a voltage control oscillator (VCO) used to implement the harmonic boosting technique of the present invention;

FIG. 3 depicts a schematic diagram of a digital synthesizer or frequency multiplier used to implement the harmonic boosting technique implemented of the present invention;

FIG. 4 is a schematic diagram of a combiner or an adder used to implement the harmonic boosting technique of the present invention;

FIG. 5 provides a schematic diagram of a digital synthesizer or frequency multiplier used to implement the harmonic boosting technique implemented of the present invention;

FIG. 6 is a schematic diagram of a digital synthesizer or frequency multiplier used to implement the harmonic boosting technique implemented of the present invention;

FIG. 7 provides a schematic diagram of a down converter used to implement the harmonic boosting technique of the present invention;

FIG. 8 illustrates a schematic diagram of an up converter used to implement the harmonic boosting technique of the present invention;

FIG. 9 provides an illustration of a schematic diagram of the APDP harmonic down-conversion mixer, for the receiving mixer basis;

FIG. 10 provides an illustration of a schematic diagram of the APDP harmonic up-conversion mixer, for the transmitting mixer basis;

FIG. 11 provides a schematic diagram of the modified Gilbert cell down-conversion mixer, for the receiving mixer basis;

FIG. 12 provides a schematic diagram of the modified Gilbert cell up-conversion mixer, for the transmitting mixer basis.

### DETAILED DESCRIPTION OF THE INVENTION

Preferred embodiments of the present invention are illustrated in the Figures, like numerals being used to refer to like and corresponding parts of the various drawings.

Although the present invention is described in detail, it should be understood that various changes, substitutions and alterations can be made hereto without departing from the spirit and scope of the invention as described by the appended claims.

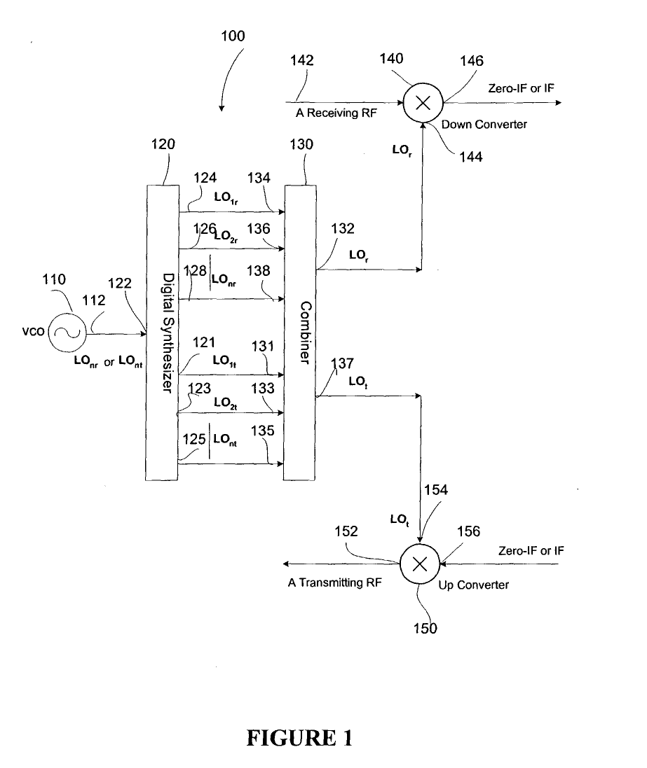

Referring to the figures in which like numerals refer to like positions thereof, FIG. 1 provides a circuit block diagram configured to implement a harmonic boosting technique for a SOC chipset or a board-level application for transceivers. VCO 110 generates output signals, LOₙᵣ=a receiving RF/2n; or LOₙₜ=a transmitting RF/2n, where n=1, 2, 3, 4 . . . at output port 112. This output is provided to digital synthesizer or frequency multiplier 120 through input port 122. Digital synthesizer or a frequency multiplier circuit 120 has two sets of n sub-output ports. The first set of outputs are from port LO₁ᵣ 124, from port LO₂ᵣ 126, and from port LOₙᵣ . . . 128. The second set of n sub-output ports are LO₁ₜ from port 121, LO^{2t} from port 123, and LOₙₜ from port 125, where: n =1, 2, 3, 4 . . . .

The following definitions are provided for those signals:

LO₁ᵣ=a receiving RF/2;

LOₙᵣ=LO₁ᵣ/n;

LO₁ₜ=a transmitting RF/2;

LOₙₜ=LO₁ₜ/n.

The signals from the two sets of n sub-ports are provided as inputs to combiner or adder circuit 130. The inputs are received at input port 134 as signal LO₁ᵣ, port 136 as signal LO₂ᵣ, port 138 as signal LOₙᵣ, port 131 as signal LO₁ₜ, port 133 as signal LO₂t, and port 135 as signal LOₙₜ. Circuit 130 combines the two n frequencies inputs together to create outputs 132 (LOᵣ) for a down converter input and 137 (LOₜ) for up converter input. An APDP circuit, a modified Gilbert circuit, or other like circuit as known to those skilled in the art, in down converter 140, mixes a received RF signal with LOᵣ 144 to produce a zero-IF or an IF signal 146. An APDP circuit, modified Gilbert cell, or other like circuit as known to those skilled in the art, in up converter 150 mixes a zero-IF signal an IF signal 156 with LOₜ 154 to produce transmitted RF output signal 152.

The present invention need not be limited to a SOC implementation. The harmonic boosting technique may also be implemented by discreted devices in a transceiver for board-level products.

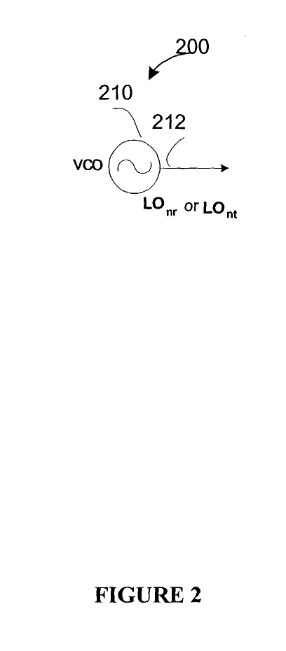

FIG. 2 functionally depicts a discrete VCO device 200 which generates output 212. Output 212 includes a frequency output which is a received RF divided by 2n, LOₙᵣ or a transmitted RF divided 2n, LO₁ₜ or both LOₙᵣ and LOₙₜ.

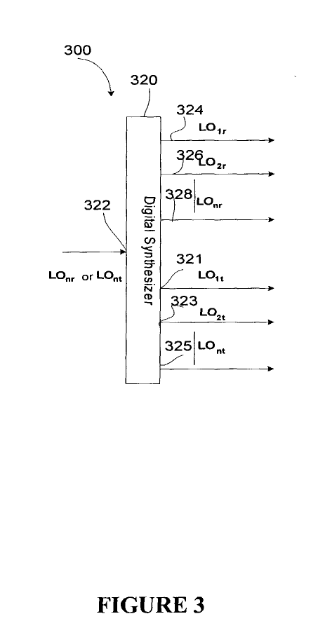

A discrete FIG. 3 functionally depicts digital synthesizer or frequency multiplier device 300 which receives the output of the VCO device 200 shown in FIG. 2 to produce an output that includes two sets of n frequency signals at output ports 324 (LO₁ᵣ), 326 (LO₂ᵣ) . . . 328 (LOₙᵣ) and port 321 (LO₁ₜ), 323 (LO₂ₜ) . . . 325 (LOₙₜ) from input LOₙᵣ or LOₙₜ, where n=1, 2, 3, 4 . . . .

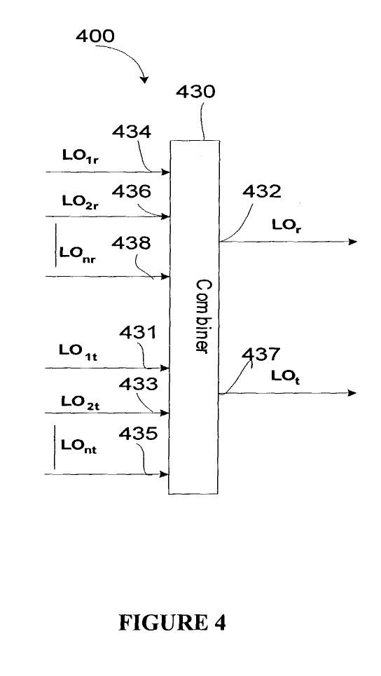

FIG. 4 functionally depicts a combiner or adder circuit 400 which combines inputs from digital synthesizer or frequency multiplier device 300. These inputs signals are shown at input ports 434 (LO₁ᵣ), 436 (LO₂ᵣ) . . . 438 (LOₙᵣ) and 431 (LO₁ₜ), 433 (LO₂ₜ) 435 (LOₙₜ) where n=1, 2, 3, 4 . . . . Combiner or adder circuit 400 produces an output (LOᵣ) at port 432 for a down converter LO frequency and an output (LOₜ) at port 437 for an up converter LO frequency.

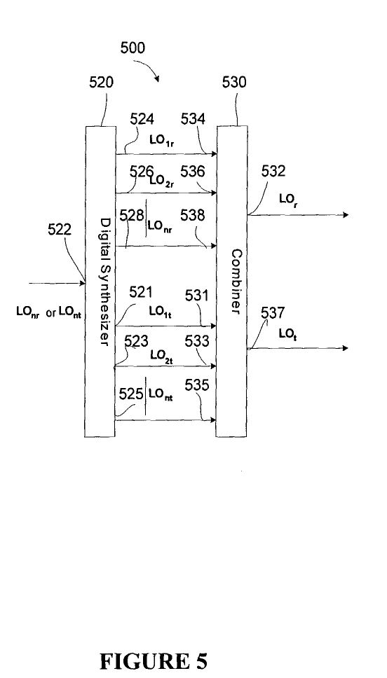

FIG. 5 depicts a single discrete board level component 500, which combines digital synthesizer or frequency multiplier circuits 520 of FIG. 3 and combiner or adder 530 of FIG. 4. This device functions similarly to the description of FIGS. 3 and 4. Digital synthesizer or frequency multiplier 520 generates a frequency output LO₁ᵣ at port 524, LO₂ᵣ at port 526, LOₙᵣ at port 528, and frequency outputs LO₁ₜ, LO₂ₜ, . . . LOₙₜ at ports 521, 523, and . . . 525, respectively, as combiner or adder inputs. Adder or combiner 530 is incorporated into one discrete device 500 and receives frequency inputs and (LO₁ᵣ), (LO₂ᵣ), (LOₙᵣ), (LO₁ₜ), (LO₂ₜ) (LOₙₜ), from ports 534, 536, 538, 531, 533, and 535, respectively, where n=1, 2, 3, 4 . . . to produce output LOᵣ at output 532 for a down converter LO frequency and output LOₜ at port 537 for a up converter LO frequency.

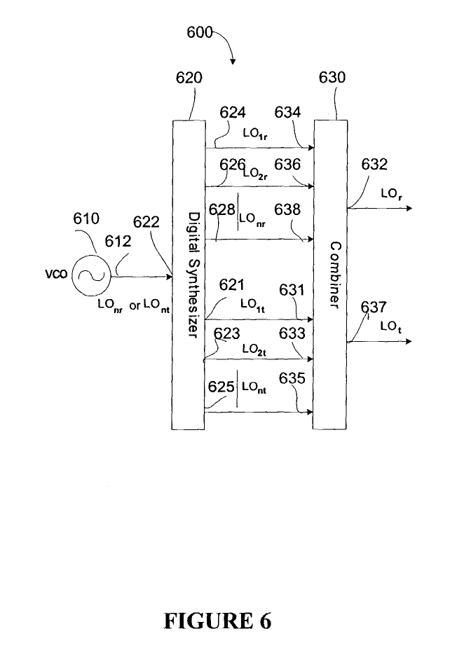

FIG. 6 depicts yet another discrete device that combines the VCO device of FIG. 2, digital synthesizer of frequency multiplier device of FIG. 3, and combiner or adder of FIG. 4, into one discrete device 600. These devices function identically to the previous descriptions in FIGS. 2, 3, and 4. VCO circuit 610 generates an output LOₙₜ or LOₙᵣ 612, which is provided to the digital synthesizer or frequency multiplier input 622. Digital synthesizer or frequency multiplier 620 generates outputs LO₁ᵣ, LO₂ᵣ, LOₙᵣ and LO₁ₜ LO₂ₜ LOₙₜ at ports 624, 626, 628, 621, 623, and 625, respectively. These outputs are received by combiner or adder ports 634, 636, 638, 631, 633, and 635, to generate output LOᵣ at port 632 for a down converter LO frequency and output LOₜ at port 637 for an up converter LO frequency.

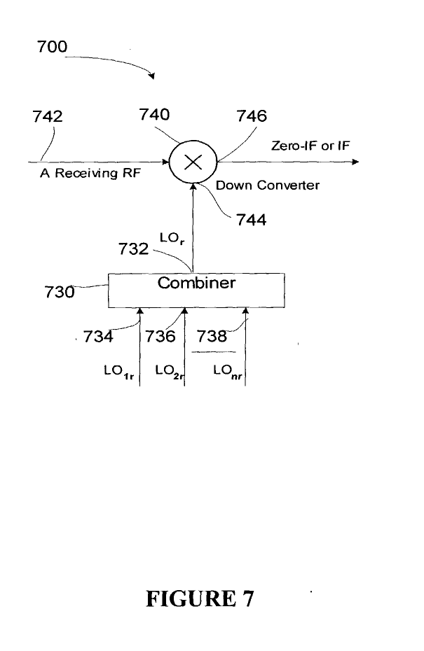

The down converter is functionally depicted as a discrete device 700 shown in FIG. 7. This circuit includes an APDP cell, a modified Gilbert cell, or other like circuit known to those skilled in the art, circuit 740 comprising LO input port 744 for signal LO₁ᵣ, RF input port 742, and zero-IF or IF output port 746. Combiner or adder 730 has a n frequency inputs from input ports 734 for signal LO₁ᵣ, 736 for signal LO₂ᵣ . . . and 738 for signal LOₙᵣ, and a output port 732 for signal LOᵣ, where n=1, 2, 3, 4 . . . and LOᵣ=a receiving RF/2 and LOₙᵣ=LO₁ᵣ/n.

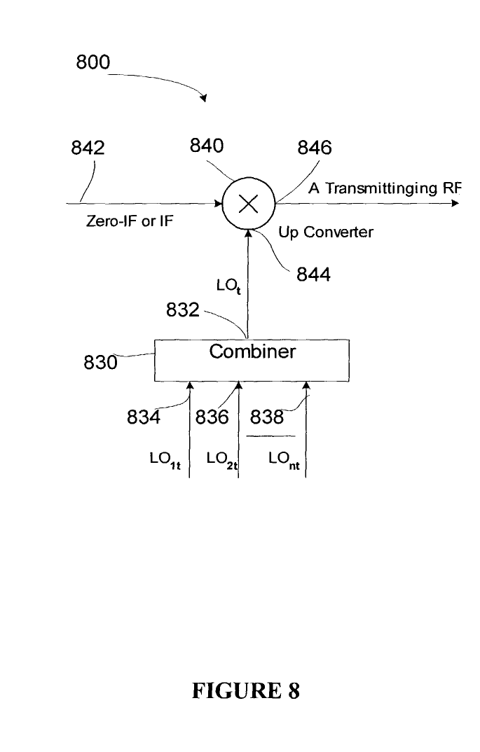

FIG. 8 functionally depicts a discrete up converter device. Up converter circuit 800 includes an APDP cell or a modified Gilbert cell circuit 840 comprising LO input port 844 for signal LOₜ and RF output port 846 and zero-IF and IF input port 846. Combiner or adder 830 has n frequencies inputs LO₁ₜ LO₂ₜ, . . . LOₙₜ, at ports 834, 836, and 838, respectively, where n=1, 2, 3, 4 . . . and LO₁ₜ=a receiving RF/2 and LOₙₜ=LO₁ₜ/n.

Measurements indicate performance having very high IIP2 (more than 50 dBM) and IIP3 (more than 20 dBM), high dynamic range (more than 95 dB), and reducing conversion loss 6 dB as well.

An APDP harmonic down-conversion mixer, a modified Gilbert cell down-conversion mixer, may be used to generate a harmonic signal in the receiving path. An APDP harmonic up-conversion mixer, or a modified Gilbert cell up-conversion mixer also may be utilized to generate a harmonic signal in the transmitting path.

A nonlinear device, such as active/passive device, transistors (or tubes)/diodes, has a voltage transfer function that could be written as a Taylor series as follows:

$${v}_{out} = {a}_{0} + {a}_{1} {v}_{in} + {a}_{2} {v}_{in}^{2} + {a}_{3} {v}_{in}^{3} + {a}_{4} {v}_{in}^{4} + {a}_{5} {v}_{in}^{5} + … . \qquad ( 1 )$$

The aᵢvᵢₙⁱ into a same bandwidth via a up/down conversion mixers generating, with a local oscillator (LO) frequency

$$\frac{1}{i} {f}_{LO}^{i} .$$

An adder sums up the signals in the system, which are boosted to generate the desired signal. Here, the i is 1, 2, 3, 4, 5 . . . , n and so on. The desired signal S can be indicated as following.

$$S = {\sum }_{0}^{n} {a}_{i} {v}_{in}^{i} in a same intermodulation / analog baseband \qquad ( 2 )$$

Basically, the up/down conversion mixer, with a local oscillator frequency

$$\frac{1}{i} {f}_{LO}^{i} ,$$

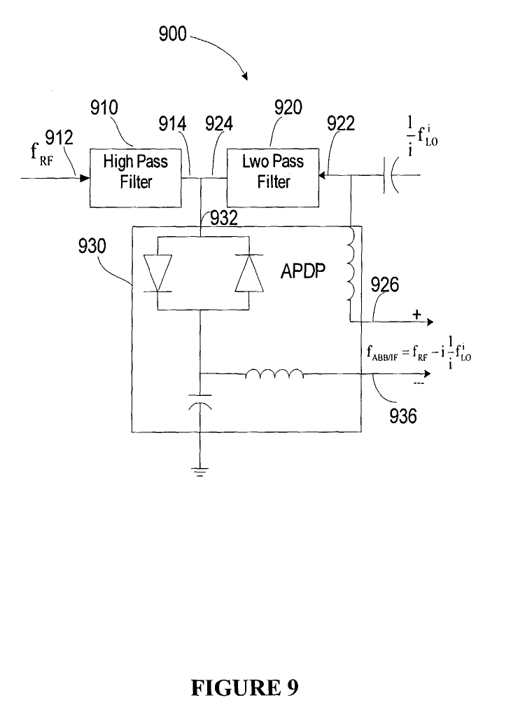

converts the fundamental frequency and the harmonic to one IF/Analog/RF baseband. Then, these are summed to become the boosted to the desired signal strength as shown in equation 2. The embodiment depicted in FIG. 9 includes a passive mixer, anti-parallel diode pair (APDP) harmonic mixer or active mixer, modified Gilbert cell mixer. A schematic diagram of the APDP harmonic down-conversion mixer 900, for the receiving mixer basis, again is illustrated in FIG. 9. This Figure depicts a high pass filter 910 which receives input f_{RF}. Low pass filter 920 receives input

$$\frac{1}{i} {f}_{LO}^{i}$$

922. High pass filter 910 and low pass filter 920 are connected to APDP 930. Output f_{ABB/1F} is provided at ports 926 and 936 and is defined as:

$${f}_{ABB / 1 F} = {f}_{RF} - i \frac{1}{i} {f}_{LO}^{i}$$

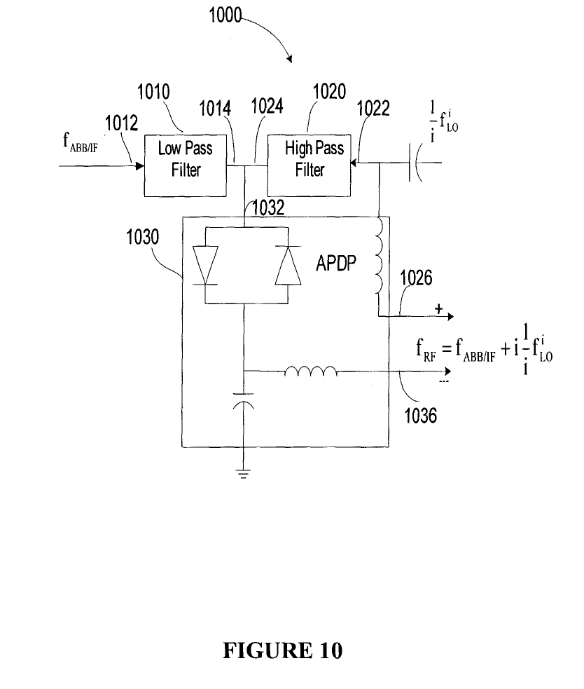

A schematic diagram of the APDP harmonic up-conversion mixer 1000, for the transmitting mixer basis, is illustrated in FIG. 10. This circuit is similar in construction as that of FIG. 9. However, the arrangement of the high and low pass filters are reversed. High pass filter 1020 receives input

$$\frac{1}{i} {f}_{LO}^{i}$$

1022. Low pass filter 1010 receives input f_{ABB/IF}. 1012 The generated output is f_{RF} at points 1026 and 1036. and is defined as:

$${f}_{RF} = {f}_{ABB / 1 F} + i \frac{1}{i} {f}_{LO}^{i}$$

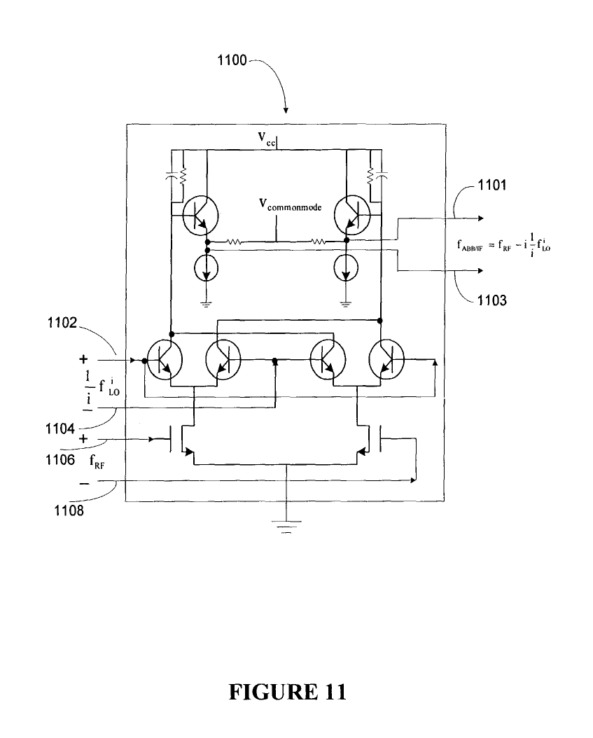

FIG. 11 provides a schematic diagram of the modified Gilbert cell down-conversion mixer 1100. The modified Gilbert cell down-conversion mixer 1100 receives input f_{RF} at ports 1106 and 1108, and receives input

$$\frac{1}{i} {f}_{LO}^{i}$$

at ports 1102 and 1104. Output f_{ABB/1F} is provided at ports 1101 and 1103 and is defined as:

$${f}_{ABB / 1 F} = {f}_{RF} - i \frac{1}{i} {f}_{LO}^{i}$$

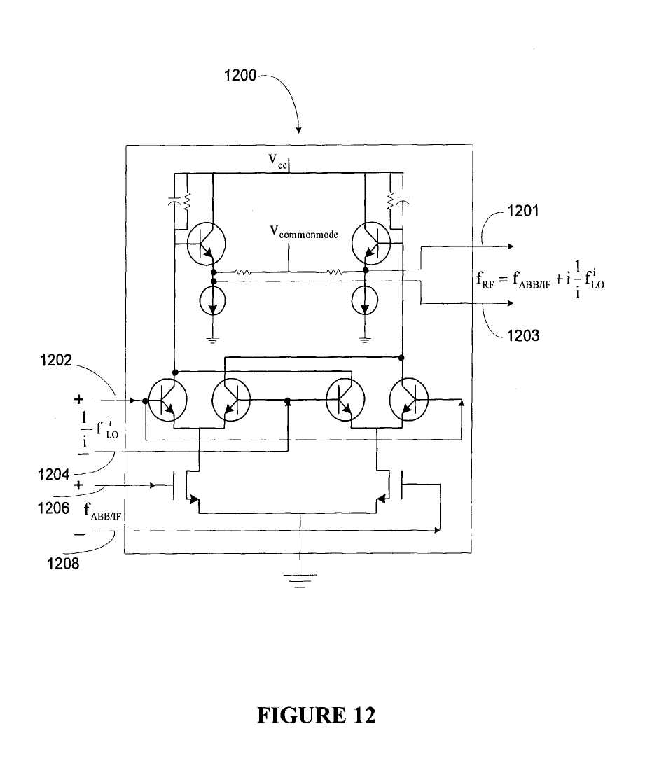

FIG. 12 provides a schematic diagram of the modified Gilbert cell up-conversion mixer. The modified Gilbert cell up-conversion mixer 1200 receives input f_{ABB/1F} at ports 1206 and 1208 and receives input

$$\frac{1}{i} {f}_{LO}^{i}$$

at ports 1202 and 1204. Output f_{RF} is provided at ports 1201 and 1203 and is defined as:

$${f}_{RF} = {f}_{\frac{ABB}{1 F}} + i \frac{1}{i} {f}_{LO}^{i}$$

The present invention provides many advantages. A desired signal in the system architecture of the present invention, is a product of harmonic signals, summed from harmonic signals. There are several significant advantages to this architecture. First, the present invention allows for lower power consumption. Harmonic signals boost the desired signal strength. This means a decrease in amplifier number, and a gain value in each amplifier stage as well. This is especially true in the case involving high power amplifier within a transmitter. Thus, the APDP mixer dose not require the current consumption levels of other solutions seen during no signal intervals.

The present invention also provides an improved Noise Figure. Converting the harmonic signals into the desired signal reduces the system noise figure.

Additionally, the present invention provides a higher voltage gain as the desired signals are summed from each harmonic.

Since most of the internal components are diodes, the device may be easily miniaturized and manufactured using CMOS technology as an integrated SOC. Alternatively, the present invention may use discrete board level components to implement the method of the present invention.

In summary, the present invention provides a harmonic boosting technique for achieving higher overall system performance. The technique may be applied using discrete devices such as converter, combiner, synthesizer, and voltage control oscillator. A converter uses an anti-parallel diode pair cell or a modified Gilbert cell circuit to combine or mix an input signal with local oscillator (hereinafter called LO). A combiner uses combining circuitry to combine harmonics from the LO. A synthesizer, using a digitally synthesized network or a multiplier circuit, produces the harmonics. A voltage control oscillator with a voltage control circuit generates very low base frequencies.

The present invention demonstrates that harmonic boosting technique can reduce LO power and frequency thus providing necessary solutions for achieving SOC chipset commercialization. In addition to the compact size, the SOC process using this technique has lower cost, lower internal interference, lower power consumption and high lineraity.

Although the present invention has been described in detail, it should be understood that various changes, substitutions and alterations can be made hereto without departing from the spirit and scope of the invention as described by the appended claims.

What is claimed is:

1. A harmonic boosting technique that uses reduced LO power and frequency, comprising the steps of:
generating an output with a voltage controlled oscillator (VCO), wherein the outputs comprise LOₙᵣ or LOₙₜ, and wherein the outputs are received by a digital synthesizer or frequency multiplier device;
producing two sets of output signals for the digital synthesizer or frequency multiplier device at n sub-output ports;
combining these two sets of output signals with an input in a combiner or adder circuit to generate a first input for a down converter and a second input for an up converter;
mixing a received RF signal with the first input with the down converter to produce a zero-IF or an IF signal; and
mixing a zero-IF signal or an IF signal with the second input within the up converter to produce a transmitting RF output signal.

2. The method of claim 1, wherein LOₙᵣ is equal to LO₁ᵣ/n and LO₁ᵣ is equal to a receiving RF; and wherein LOₙₜ is equal to LO₁ₜ/n and LO₁ₜ is equal to a transmitting RF/2.

3. The method of claim 1, wherein the two sets of output signals comprise:
LO₁ᵣ, LO₂ᵣ . . . LOₙᵣ at a first set of sub-output ports; and
LO₁ₜ, LO₂ₜ . . . LOₙₜ where n 1, 2, 3, 4 . . . ; at a second set of sub-output ports.

4. The method of claim 1, wherein the inputs have frequencies LO₁ᵣ, LO₂ᵣ . . . LOₙᵣ and LO₁ₜ, LO₂ₜ . . . LOₙₜ.

5. The method of claim 1, wherein said first input is LOᵣ and said second input is LOₜ.

6. The method of claim 1, wherein said down converter comprises an anti-parallel diode pair circuit or a modified Gilbert circuit.

7. The method of claim 1, wherein said down converter comprises an anti-parallel diode pair circuit or a modified Gilbert circuit.

8. The method of claim 1, wherein said steps are executed by circuits within a single CMOS or SiBiCMOS chip.

9. The method of claim 1, wherein said steps are executed by discrete devices mounted on a circuit board.

10. An apparatus to harmonically boost signals in order to reduce LO power and frequency, comprising:
a voltage controlled oscillator (VCO) which generates outputs LOₙᵣ or LOₙₜ;
a digital synthesizer or frequency multiplier device that receives outputs LOₙᵣ or LOₙₜ from the voltage controlled oscillator and produces two sets of output signals at n sub-output ports;
a combiner or adder circuit that combines these two sets of output signals with an input to generate a first input for a down converter and a second input for an up converter;
a RF signal which is mixed with the first input in the down converter to produce a zero-IF or an IF signal; and
a transmitting RF output signal produced by mixing the zero-IF signal or IF signal with the second input within the up converter.

11. The apparatus of claim 10, wherein LOₙᵣ is equal to LO₁ᵣ/n and LO₁ᵣ is equal to a receiving RF/2; and Wherein LOₙₜ is equal to LO₁ₜ/n and LO₁ₜ is equal to a transmitting RF/2.

12. The apparatus of claim 10, wherein the two sets of output signals comprise:
LO₁ᵣ, LO₂ᵣ . . . LOₙᵣ at a first set of sub-output ports; and
LO₁ₜ, LO₂ₜ . . . LOₙₜ where n=1, 2, 3, 4 . . . ; at a second set of sub-output ports.

13. The apparatus of claim 10, wherein the inputs have frequencies LO₁ᵣ, LO₂ᵣ . . . LOₙᵣ and LO₁ₜ, LO₂ₜ . . . LOₙₜ.

14. The apparatus of claim 10, wherein said first input is LOᵣ and said second input is LOₜ.

15. The apparatus of claim 10, wherein said down converter comprises an anti-parallel diode pair circuit or a modified Gilbert circuit.

16. The apparatus of claim 10, wherein said down converter comprises an anti-parallel diode pair circuit or a modified Gilbert circuit.

17. The apparatus of claim 10, wherein said steps are executed by circuits comprising a System on Chip.

18. The apparatus of claim 10, wherein said steps are executed by discrete devices mounted on a circuit board.

19. The apparatus of 18, wherein said voltage control oscillator comprises a discrete board level component.

20. The apparatus of 18, wherein said digital synthesizer or frequency multiplier device comprise a discrete board level component.
